(19) United States
(12) Patent Application Publication
(10) Pub. No.: US 2026/0033479 A1
(43) Pub. Date: Feb. 5, 2026

(54) Hand-Held Rodent Trap Setting Device

(71) Applicant: Vasile OROS, Menlo Park, CA (US)

(72) Inventor: Vasile OROS, Menlo Park, CA (US)

(21) Appl. No.: 18/793,813

(22) Filed: Aug. 4, 2024

(51) Int. Cl. A01M 23/24; A01M 23/30

(52) U.S. Cl. CPC A01M 23/245; A01M 23/30

(57) ABSTRACT

In some embodiments, a hand-held rodent trap setting device, or rat trap gun, includes a base supporting a rodent trap, a handle, a clamping arm that clamps down the rodent trap to the platform when engaged, and an actuator coupled to clamping arm and configured to clamp down and release the clamping arm. The clamping arm may be part of a toggle clamp that presses down directly on the trap platform. A pulling arm may be used to pull a kill bar of the rodent trap into an armed/set position. A safety catch, which moves jointly with the clamping arm, engages the kill bar to prevent the kill bar from snapping. A cocking actuator operated by a thumb and/or a trigger actuator operated by fingers may be used to clamp/release the clamping arm. A device sized for rat traps may be used to set mouse traps via an appropriately-sized adapter.

### BACKGROUND

The invention relates to rodent control devices, and in particular to devices for facilitating setting rat and mouse traps.

A common rat trap design includes a U-shaped, spring-loaded kill bar held down by an arm bar. A rodent attempting to retrieve bait dislodges the arm bar, which allows the kill bar to snap down onto the rodent.

Setting up, transporting and positioning can be difficult and frightening. To prevent rodents from getting the bait without triggering the trap, the arm bar placement is commonly sensitive to small movements, which increases the risk of the kill bar snapping onto the user's hand while the trap is being set. A number of US patents describe various approaches to making rodent traps safer and easier to use.

In U.S. Patent Publication No. 2006/0064922, Crispens et al. describe a safety arm that prevents accidental discharge of the bow of a spring-loaded mouse trap. A user can rotate the safety arm with a lever to permit the bow of the mouse trap to rotate unimpeded after the trap is set.

In U.S. Pat. No. 4,825,579, Dzurkovich et al. describe a disposable cartridge assembly for use with a rodent trap. A rodent enters a sleeve mounted adjacent to the trap trigger, activates the trigger and is trapped. The entire assembly is then disposed. The assembly includes a safety catch that may be slipped over the trap crossbar to prevent the striker from releasing prematurely and striking the user's fingers.

In U.S. Pat. No. 6,199,314, Ballard describes a housing adapted to receive a platform of a conventional mouse trap. A cocking handle includes a pair of handle arms attached to pivotal connections on the side, and terminating at a cross bar. A pair of bow-urging arms are also attached to the pivotal connections. By rotating the cocking handle, the bow urging arms urge the bow to a cocked position. A catch member is pivoted inward to maintain the bow in the cocked position until the locking arm of the mouse trap is engaged in the bait pedal of the mouse trap.

### SUMMARY

According to one aspect, a hand-held rodent trap-setting device includes: a base for supporting a platform of a rodent trap; a handle coupled to the base and extending generally below the base, for allowing a user to hold the trap-setting device; a clamping arm coupled to the base and configured to contact a top surface of the rodent trap platform to clamp down the rodent trap platform onto the base; and an actuator coupled to the base and to the clamping arm, operable by the user, and configured to engage and release the clamping arm onto/from the rodent trap platform.

According to another aspect, a method of setting a rodent trap comprises: holding a handle of a hand-held rodent trap-setting device in a first hand, the handle being coupled to a base of the trap-setting device and extending generally below the base; mounting a rodent trap onto the base; engaging an actuator coupled to the base and to a clamping arm of the trap-setting device to clamp down the rodent trap onto the base using the clamping arm, the clamping arm contacting a top surface of a platform of the rodent trap; and setting the rodent trap while clamped down onto the base.

### BRIEF DESCRIPTION OF THE DRAWINGS

The foregoing aspects and advantages of the present invention will become better understood upon reading the following detailed description and upon reference to the drawings where:

FIG. 1-A shows an isometric view of a hand-held rodent trap setting device according to some embodiments of the present invention.

FIG. 1-B shows an isometric view of the hand-held rodent trap setting device of FIG. 1-A holding a rodent trap while the rodent trap is being armed, according to some embodiments of the present invention.

FIG. 1-C shows an isometric view of the hand-held rodent trap setting device and rodent trap of FIG. 1-B with the rodent trap in a set configuration, according to some embodiments of the present invention.

FIG. 1-D shows isometric views of parts of a linking assembly (e.g. modified toggle clamp) of the hand-held rodent trap setting device of FIG. 1-A according to some embodiments of the present invention.

FIGS. 2-A-B show isometric views of another hand-held rodent trap setting device according to some embodiments of the present invention.

FIG. 2-C shows an isometric view of the hand-held rodent trap setting device of FIGS. 2-A-B and a rodent trap with the rodent trap in an armed configuration, according to some embodiments of the present invention.

FIGS. 3-A shows an isometric view of another hand-held rodent trap setting device while the kill bar slides past a safety catch according to some embodiments of the present invention.

FIGS. 3-B shows an isometric view of the trap setting device of FIG. 3-A while the kill bar is secured by a safety catch and before an arm bar secures the kill bar, according to some embodiments of the present invention.

FIGS. 3-C shows an isometric view of the trap setting device of FIG. 3-A while the kill bar is secured by a safety catch and after an arm bar secures the kill bar, according to some embodiments of the present invention.

FIGS. 3-D illustrates a release of the armed rodent trap from the trap setting device of FIG. 3-C according to some embodiments of the present invention.

FIGS. 3-E-F show isometric views of a clamping arm assembly of the trap-setting device of FIGS. 3-A-D in closed and open configurations, respectively, according to some embodiments of the present invention.

FIGS. 4-A shows an isometric view of mouse trap adapter that can be used in conjunction with a rat trap setting device as shown in FIGS. 1-A-3-F according to some embodiments of the present invention.

FIGS. 4-B shows an isometric view of a mouse trap disposed within the mouse trap adapter of FIG. 4-A according to some embodiments of the present invention.

FIG. 4-C shows an isometric view of a mouse trap disposed within the mouse trap adapter of FIG. 4-A, which is in turn secured within a rat trap setting device as shown in FIGS. 1-A-D according to some embodiments of the present invention.

FIG. 5-A shows an isometric view of a hand-held rodent trap setting device having a pulling arm in an initial configuration, prior to the rodent trap arm being set, according to some embodiments of the present invention.

FIG. 5-B shows an isometric view of the hand-held rodent trap setting device of FIG. 5-A holding a rodent trap while the rodent trap is being armed, according to some embodiments of the present invention.

FIG. 5-C shows an isometric view of a hand-held rodent trap setting device having a pulling arm and integrated clamping arm, and a rodent trap with the rodent trap in a set configuration, according to some embodiments of the present invention.

FIG. 5-D shows an isometric view of another hand-held rodent trap setting device with the rodent trap in a set configuration, according to some embodiments of the present invention.

FIG. 5-E shows isometric views of parts of a linking assembly of the hand-held rodent trap setting devices of FIGS. 5-A-B according to some embodiments of the present invention.

### DETAILED DESCRIPTION

The following description illustrates the present invention by way of example and not necessarily by way of limitation. A set of elements includes one or more elements. A plurality of elements includes two or more elements. Any recitation of an element is understood to refer to at least one element. Unless otherwise required, any described method steps need not be necessarily performed in a particular illustrated order. Any recited connection encompasses a direct connection as well as an indirect connection through an intermediary structure. An actuator is a lever, button, member or other mechanical structure that actuates (initiates and/or causes a movement of) other structures, such as a clamping arm, that are coupled to the actuator.

An actuator need not be, and in preferred embodiments is not, powered by electrical or pneumatic forces; in some embodiments an actuator may be powered and controlled by a human hand applying force.

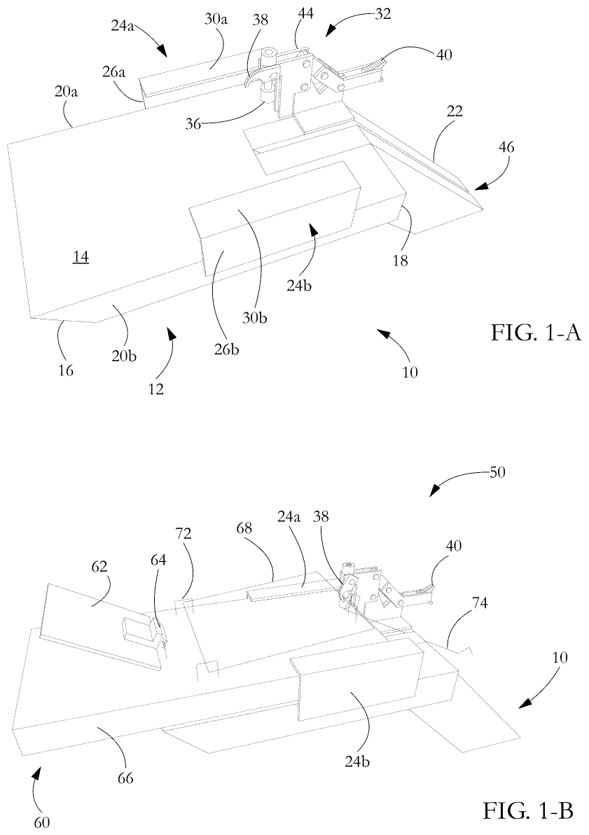

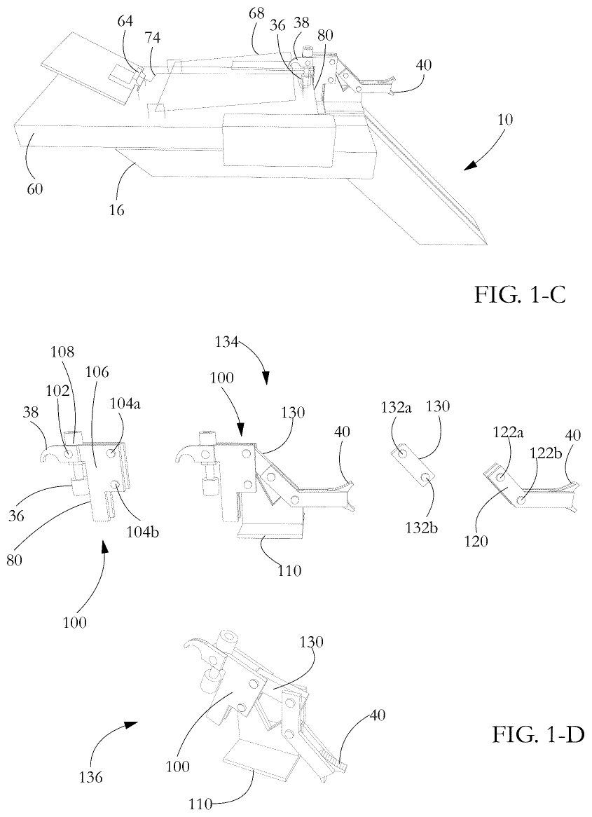

FIG. 1-A shows an isometric view of a hand-held rodent trap setting device 10 according to some embodiments of the present invention. Trap setting device 10 includes a base 12 having a planar upper surface 14 configured to support a rodent trap 60, shown in FIG. 1-B. As shown in FIG. 1-A, base 12 has a beveled/angled front/distal surface 16, shaped to facilitate setting down the trap on the floor after arming, as described below. A rear/proximal surface 18 of base 12 faces the arm of an end user holding trap setting device 10 during its operation. Opposite lateral faces 20a-b of base 12 extend laterally between front surface 16 and rear surface 18. As illustrated, base 12 may have a continuous/solid upper surface 14. In some embodiments, upper surface 14 may be shaped as a frame having one or more internal openings.

A handle 22 is attached to base 12 along the rear side of base 12, and extends generally downward and outward from base 12. A pair of lateral trap guides 24a-b are situated opposite each other along corresponding lateral sides 20a-b. Trap guides 24a-b include corresponding vertical sides 26a-b mounted on and extending upward from base 12, and horizontal covers 30a-b extending inward from vertical sides 26a-b. Horizontal covers 30a-b are separated from upper surface 14 by a vertical distance slightly larger than the thickness of the platform of a rodent trap, so that the platform may be slid under and kept in place by horizontal covers 30a-b.

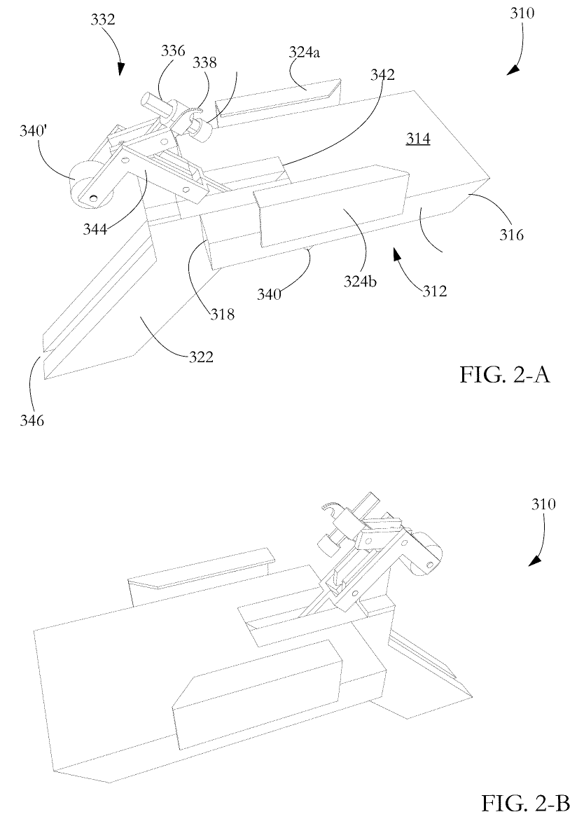

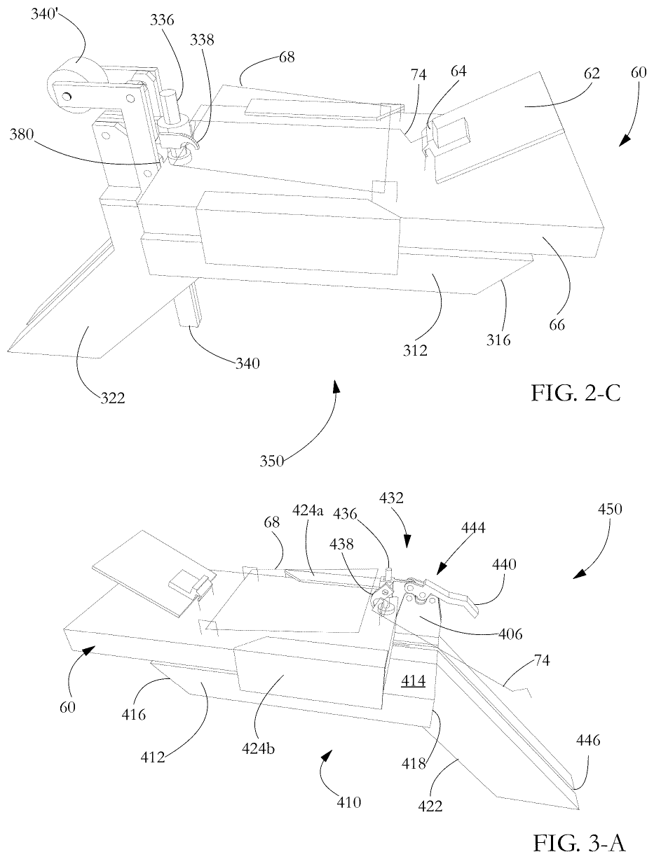

A clamping arm assembly 32 is attached to base 12 along the rear side of base 12, and extends generally upward from base 12, above upper surface 14. Clamping arm assembly 32 may be a modified toggle clamp, in particular modified to include a backstop as described below. Clamping arm assembly 32 includes a vertical clamping arm (clamping bar) 36 having a tip (pad) made of rubber or similar adherent and/or clastic material, adjustable vertically and configured to press down and secure the rodent trap platform between clamping arm 36 and base 12. Clamping arm assembly 32 further includes a spring-loaded kill bar safety catch (extension) 38 mounted on a horizontal pivot, configured to secure the rodent trap kill bar while the rodent trap is being set, as described in detail below. Safety catch 38 is mounted on or along clamping arm 36, such that safety catch 38 and clamping arm 36 move jointly in response to the user operating an actuator, described below. In some embodiments, safety catch 38 may be mounted directly on clamping arm 36, or on a body/extension onto which clamping arm 36 is mounted. Safety catch 38 may include or be connected to a spring controlling its rotation relative to clamping arm 36, and a stop constraining the motion of safety catch 38. Clamping arm assembly 32 further includes a thumb-operated clamping arm actuator 40 extending rearwardly from base 12, and mounted on a horizontal pivot. In the illustrated embodiment, actuator 40 is or includes a lever. A linker assembly 44 comprises a plurality of linked parts, described in further detail with reference to FIG. 1-D, configured to convert a thumb-actuated vertical motion of actuator 40 into a corresponding vertical motion of clamping arm 36 and safety catch 38. A generally-longitudinal slit/aperture 46 runs along a middle of handle 22 partially or all the way down, and extends partially along top surface 14 of base 12. Slit 46 accommodates a rodent trap arm bar during a process of setting the rodent trap, as described below, to keep the rodent trap arm in place while the user is focused on other parts of the device. Slit 46 may also accommodate a trigger-type actuator, as described below with reference to FIGS. 2-A-B.

FIG. 1-B shows an isometric view of a rodent trap setting assembly 50 comprising the hand-held rodent trap setting device 10 of FIG. 1-A holding a rodent trap 60 while rodent trap 60 is being armed, according to some embodiments of the present invention. As shown, a bait station 62 and corresponding arm bar connector 64 are mounted on a rodent trap base 66, alongside a kill bar 68 and corresponding arm bar 74. Kill bar 68 is mounted on platform 66 via a spring-loaded pivot 72. As kill bar 68 is lowered, under tension, onto the proximal (rear) side of trap 60, kill bar 68 engages an outer, arcuate surface of safety catch 38, causing spring-loaded safety catch 38 to pivot downward under spring tension and allow kill bar 68 to slide below safety catch 38. During this process arm bar 74 may be conveniently positioned within slit 46.

FIG. 1-C shows an isometric view of rodent trap setting assembly 50 comprising the hand-held rodent trap setting device 10 and rodent trap 60 of FIG. 1-B with the rodent trap in an armed configuration, according to some embodiments of the present invention. As shown, an inner, convex surface of safety catch 38 engages kill bar 68 and prevents kill bar 68 from moving upward while a user safely secures arm bar 74 into the arm bar connector 64 of the trap bait station. Clamping arm 36 presses down on the platform of rodent trap 60, securing rodent trap 60 against the base of setting device 10 and preventing the motion/sliding of rodent trap 60 relative to the upper surface of setting device 10. As illustrated, clamping arm 36 presses down on the rodent trap platform in the limited area between kill bar 68 and the rear edge of the rodent trap platform. A linker assembly backstop 80 abuts against the rear of the rodent trap platform, preventing backward motion of rodent trap 60 once rodent trap 60 is aligned so that clamping arm 36 is aligned with the limited area between kill bar 68 and the rear edge of the rodent trap platform. Moving actuator 40 up and down under the control of a user's thumb/finger leads to rotation of the assembly comprising clamping arm 36 and backstop 80. In particular, the rotational motion has components including a vertical, up/down motion of clamping arm 36 that clamps/releases trap 60, and a longitudinal, front/back motion of backstop 80 that accommodates/pushes out rodent trap 60. When trap 60 is to be secured within device 10, pressing up on actuator 40 moves backstop 80 rearward and clamping arm 36 downward. The resulting configuration is shown in FIG. 1-C and at 134 in FIG. 1-D. Conversely, after trap 60 has been set and a user wishes to release trap 60 from device 10, pressing down on actuator 40 moves backstop 80 forward and clamping arm 36 upward, which releases trap 60 and pushes it forward (via backstop 80), facilitating its placement at a desired location. The resulting configuration is shown at 136 in FIG. 1-D.

The angled shape of beveled front surface 16 further facilitates placing trap 60 on a flat surface such as a floor, by facilitating sliding device 10 from under trap 60 without dropping the set trap on the floor and/or triggering/snapping the trap.

As may be seen most easily in FIG. 1-A, clamping bar 36 and safety catch 38 are positioned off-center with respect to the central longitudinal (front-back) axis of device 10, and in particular to the right of center when looking forward from the rear to the front of device 10. Off-center placement provides room for the arm bar, and placement on the right side makes it easier to set trap 60. Some rodent traps have asymmetric connections between the arm bar and corresponding bait station connector. For such asymmetric designs, placing safety catch 38 on the right side of the central longitudinal axis of the trap makes the arm bar connection to the bait station easier to set than placing the safety catch on-center or on the other side of the central longitudinal axis. Off-center placement results in a small tilt of the kill bar, which is favorable for a commonly-used rodent trap design using a metal bait station.

FIG. 1-D shows isometric views of parts of linker assembly 44 of FIGS. 1-A-C according to some embodiments of the present invention. A clamped-down configuration is shown at 134, while a released configuration is shown at 136. A support 100 is mounted on base 12 (FIGS. 1-A-C) through a mount 110: mount 110 is affixed to base 12, and support 100 is in turn pivotably mounted on mount 110. Support 100 includes a body 106 mountable on mount 110, a frontal horizontal pivot 102 defined on a frontal extension 108 of body 106, and rear horizontal pivots 104a-b. Clamping arm 36 and safety catch 38 are pivotably mounted on pivot 102. At least safety catch 38 is spring loaded, so as to allow safety catch 38 to pivot downward when pressed upon by a trap kill bar, and snap back up after the kill bar has passed underneath safety catch 38. A lower/downward extension of body 106 defines backstop 80. Linking arm 130 and mount 110 are connected to rear pivots 104a-b, respectively. Linking arm 130 includes a front pivot 132a coupled to body 106 at pivot 104a, and a rear pivot 132b coupled to a pivot 122a of a rearward arm 120, to which actuator 40 is coupled. Rearward arm 120 further includes a pivot 122b coupled to body 106 at pivot 104b. Linker assembly 44 may be made by modifying a toggle clamp to include the illustrated downward extension defining backstop 80.

FIGS. 2-A-B show isometric views of another hand-held rodent trap setting device 310 according to some embodiments of the present invention. Trap setting device 310 is similar to the device 10 shown in FIGS. 1-A-C, except that it has a different actuator and linking arm design for operating the clamping arm and/or safety catch, as described below. Trap setting device 310 includes a base 312 having a planar upper surface 14 configured to support a rodent trap 60, shown in FIG. 2-C. As shown in FIG. 2-A, base 312 has a beveled/angled front/distal surface 316, shaped to facilitate setting down the trap on the floor after arming, as described below. A rear/proximal surface 318 of base 312 faces the arm of an end user holding trap setting device 310 during its operation.

A handle 322 is attached to base 312 along the rear side of base 312, and extends generally downward and outward from base 312. A pair of lateral trap guides 324a-b are situated opposite each other along corresponding lateral sides of base 312.

A clamping arm assembly 332 is attached to base 312 along the rear side of base 312, and extends generally upward from base 312, above upper surface 314. Clamping arm assembly 332 includes a vertical clamping arm (clamping bar) 336 having a tip made of rubber or similar adherent and/or elastic material, configured to press down and secure the rodent trap platform between clamping arm 336 and base 312. Clamping arm assembly 332 further includes a spring-loaded kill bar safety catch 338 mounted on a horizontal pivot, configured to secure the rodent trap kill bar while the rodent trap is being set, as described in detail below. Clamping arm assembly 332 further includes a finger- and thumb-operated clamping arm actuator 340 extending downward through a transverse aperture 342 defined through base 312 and coupled through a horizontal pivot to base 312, and a thumb-operated camping arm actuator 340′ extending rearwardly from clamping arm 336. A linker assembly 344 comprises a plurality of linked parts, configured to convert a finger-actuated generally-longitudinal motion of actuator 340 and a thumb-actuated generally-longitudinal, downward motion of actuator 340′ into corresponding vertical (downward and upward, respectively) motions of clamping arm 336 and safety catch 338. A generally-longitudinal slit/aperture 346 runs along a middle of handle 322, and extends partially along top surface 314 of base 312. Slit 346 accommodates a rodent trap arm bar during a process of setting the rodent trap.

FIG. 2-C shows an isometric view of rodent trap setting assembly 350 comprising the hand-held rodent trap setting device 310 and rodent trap 60 of FIG. 2-A-B with the rodent trap in an armed configuration, according to some embodiments of the present invention. As shown, a bait station 62 and corresponding arm bar connector 64 are mounted on a rodent trap base 66, alongside a kill bar 68 and corresponding arm bar 74. Kill bar 68 is mounted on platform 66 via a spring-loaded pivot 72. As kill bar 68 is lowered, under tension, onto the proximal (rear) side of trap 60, kill bar 68 engages an outer, arcuate surface of safety catch 338, causing safety catch 338 to pivot downward and allow kill bar 68 to slide below safety catch 338. During this process arm bar 74 may be conveniently positioned within slit 346 (shown in FIG. 2-A).

As shown in FIG. 2-C, an inner, convex surface of safety catch 338 engages kill bar 68 and prevents kill bar 68 from moving upward while a user safely secures arm bar 74 into the arm bar connector 64 of the trap bait station. Clamping arm 336 presses down on the platform of rodent trap 60, securing rodent trap 60 against the base of setting device 310 and preventing the motion/sliding of rodent trap 60 relative to the upper surface of setting device 310. As illustrated, clamping arm 336 presses down on the rodent trap platform in the limited area between kill bar 68 and the rear edge of the rodent trap platform. Actuator 340 abuts against the rear of the rodent trap platform, preventing backward motion of rodent trap 60 once rodent trap 60 is aligned so that clamping arm 336 is aligned with the limited area between kill bar 68 and the rear edge of the rodent trap platform. Moving actuator 340 up and down under the control of a user's thumb/finger leads to a rotational motion having longitudinal, front/back component that accommodates or pushes forward trap 60, as applicable. When trap 60 is to be secured within device 310, pulling actuator 340 backward with a user's fingers moves actuator 340 rearward and clamping arm 336 downward. Conversely, after trap 60 has been set and a user wishes to release trap 60 from device 310, pressing down with a user's thumb on actuator 340′ moves actuator 340 forward and clamping arm 336 upward, which releases trap 60 and pushes it forward (via actuator 340), facilitating its placement at a desired location. The angled shape of beveled front surface 316 further facilitates placing trap 60 on a flat surface such as a floor, by facilitating sliding device 310 from under trap 60 without dropping the set trap on the floor.

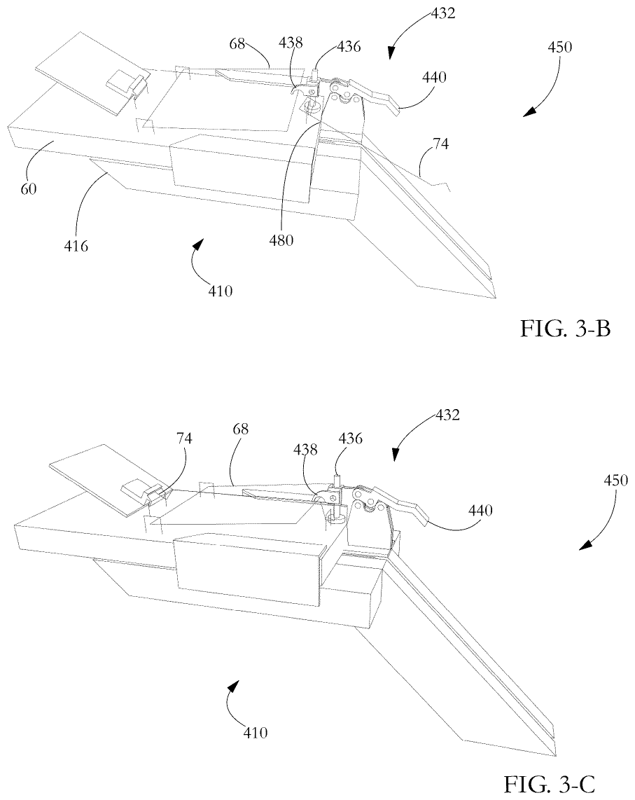

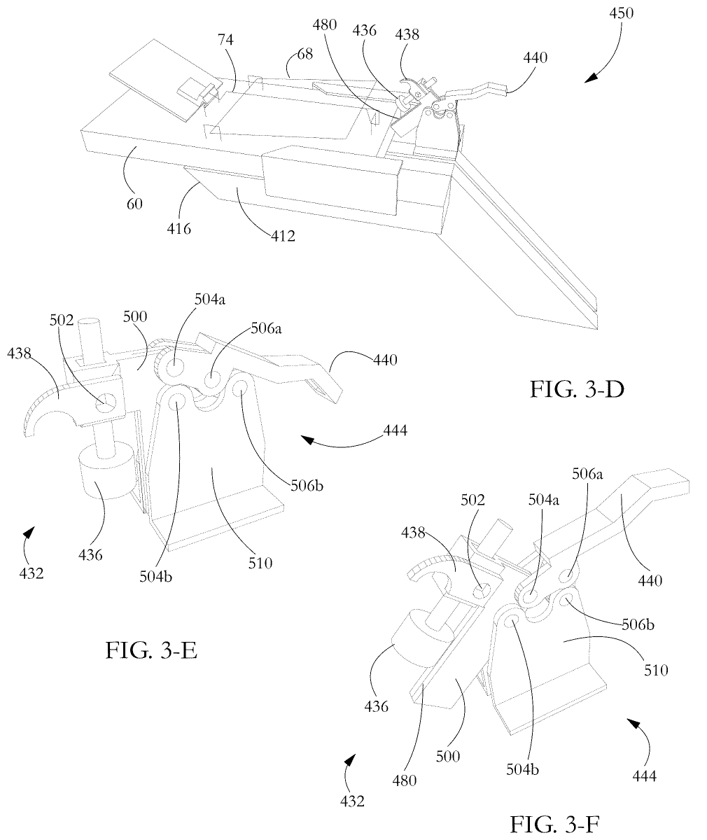

FIGS. 3-A shows an isometric view of a rodent trap assembly 450 comprising another hand-held rodent trap setting device 410 and rodent trap 60 in the process of setting rodent trap 60, according to some embodiments of the present invention. Trap setting device 410 is similar to the device 10 shown in FIGS. 1-A-C, except that it has a different actuator and linking arm design for operating the clamping arm and/or safety catch, as described below. Trap setting device 410 includes a base 412 having a planar upper surface 414 configured to support a rodent trap 60. Base 412 has a beveled/angled front/distal surface 416, shaped to facilitate setting down the trap on the floor after arming, as described below. A rear/proximal surface 418 of base 412 faces the arm of an end user holding trap setting device 410 during its operation.

A handle 422 is attached to base 412 along the rear side of base 412, and extends generally downward and outward from base 412. A pair of lateral trap guides 424a-b are situated opposite each other along corresponding lateral sides of base 412.

A clamping arm assembly 432 is attached to base 412 along the rear side of base 412, and extends generally upward from base 412, above upper surface 414. Clamping arm assembly 432 includes a vertical clamping arm 336 having a tip made of rubber or similar adherent and/or clastic material, configured to press down and secure the rodent trap platform between clamping arm 436 and base 412. Clamping arm assembly 432 further includes a kill bar safety catch 438 mounted on a horizontal pivot, configured to secure the rodent trap kill bar while the rodent trap is being set, as described in detail below. Clamping arm assembly 432 further includes a thumb-operated clamping arm actuator 440 extending rearward from base 412, and mounted on two horizontal pivots (see FIG. 3-E). A linker assembly 444 comprises a plurality of linked parts, configured to convert a thumb-actuated generally-vertical motion of actuator 440 into a vertical motion of clamping arm 436 and safety catch 438. A generally-longitudinal slit/aperture 446 runs along a middle of handle 422, and extends partially along top surface 414 of base 412. Slit 446 accommodates arm bar 74 during a process of setting the rodent trap. As kill bar 68 is lowered, under tension, onto the proximal (rear) side of trap 60, kill bar 68 engages an outer, arcuate surface of safety catch 438, causing safety catch 438 to pivot downward and allow kill bar 68 to slide below safety catch 438. During this process arm bar 74 may be conveniently positioned within slit 446.

FIG. 3-B shows an isometric view of rodent trap setting assembly 450 comprising the hand-held rodent trap setting device 410 and rodent trap 60 of FIG. 3-A with kill bar 68 in an armed configuration, and FIG. 3-C illustrates assembly 450 with arm bar 74 secured within its corresponding bait station connector, according to some embodiments of the present invention. An inner, convex surface of safety catch 438 engages kill bar 68 and prevents kill bar 68 from moving upward while a user safely secures arm bar 74 into the arm bar connector 64 of the trap bait station (as shown in FIG. 3-C). Clamping arm 436 presses down on the platform of rodent trap 60, securing rodent trap 60 against the base of setting device 410 and preventing the motion/sliding of rodent trap 60 relative to the upper surface of setting device 410. As illustrated, clamping arm 436 presses down on the rodent trap platform in the limited area between kill bar 68 and the rear edge of the rodent trap platform. A linker assembly backstop 480 abuts against the rear of the rodent trap platform, preventing backward motion of rodent trap 60 once rodent trap 60 is aligned so that clamping arm 436 is aligned with the limited area between kill bar 68 and the rear edge of the rodent trap platform. Moving actuator 440 up and down under the control of a user's thumb/finger leads to a longitudinal, front/back motion of backstop 480. When trap 60 is to be secured within device 10, pressing down on actuator 440 moves backstop 480 rearward and clamping arm 436 downward.

FIG. 3-D illustrates a release of trap 60 from device 410. After trap 60 has been set and a user wishes to release trap 60 from device 410, pressing up on actuator 440 moves backstop 480 forward and clamping arm 436 upward, which releases trap 60 and pushes it forward (via backstop 480), facilitating its placement at a desired location. The angled shape of beveled front surface 416 further facilitates placing trap 60 on a flat surface such as a floor, by facilitating sliding device 10 from under trap 60 without dropping the set trap on the floor.

FIGS. 3-E-F show clamping arm assembly 432 in closed and open configurations, respectively. Clamping arm assembly 432 comprises clamping arm 436, safety catch 438, actuator 440, and a linker assembly 444 connecting actuator 440 to clamping arm 436 and safety catch 438.

Linker assembly 444 comprises a support 500 coupled to base 412 (FIGS. 3-A-D) through a mount 510: mount 510 is affixed to base 412 (FIG. 3-D), and support 500 is in turn pivotably mounted on mount 510. Support 500 includes a body mountable on mount 510, a frontal horizontal pivot 502 on which clamping arm 436 and safety catch 438 are mounted, and rear horizontal pivots 504a-b establishing rearward pivotable connections to actuator 440 and mount 510, respectively. A linking arm links rear pivots 506a-b to each other. Pivot 506a is coupled to actuator 440, and pivot 506b is coupled to mount 510.

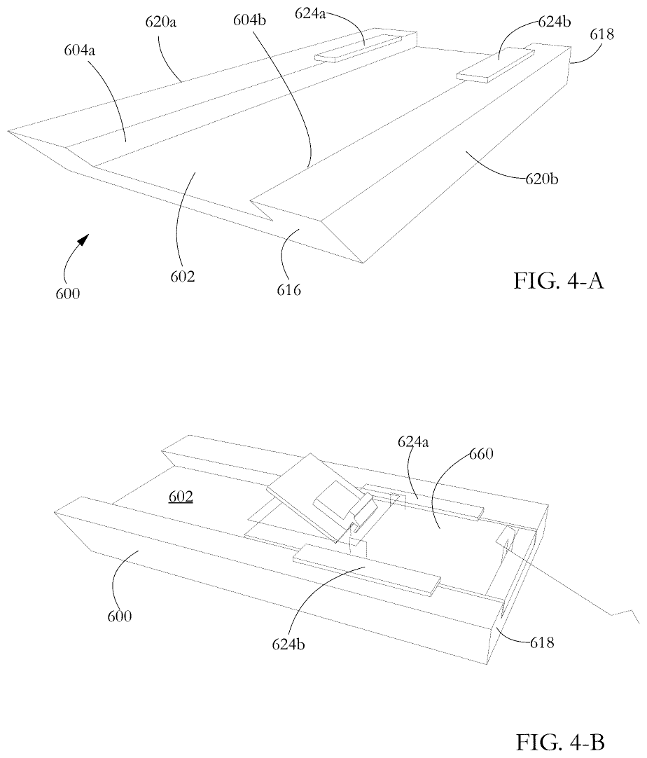

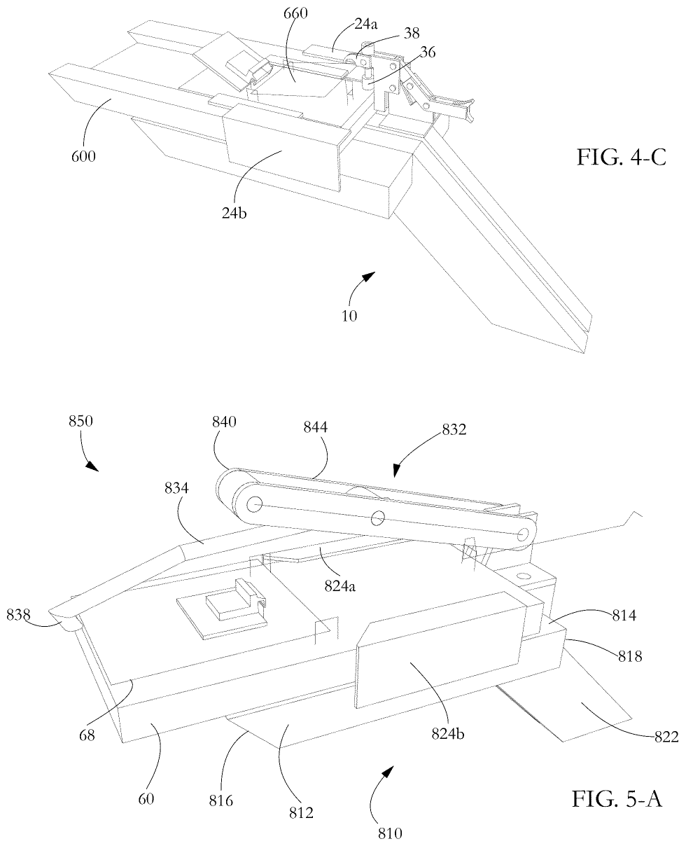

FIGS. 4-A shows an isometric view of mouse trap adapter 600 that can be used in conjunction with a rat trap setting device as shown in FIGS. 1-A-3-F according to some embodiments of the present invention. While the description below focuses on a mouse/rat trap pairing, the described structures may be used for devices/traps sized for other animals, one larger than the other. Mouse trap adapter 600 is sized generally as the platform of a rat trap (scc e.g. trap 60), and has an internal longitudinal inner channel 602 sized to receive a mouse trap (see e.g. trap 660 in FIGS. 4-B-C). Mouse trap adapter 600 has outer lateral surfaces 620a-b spaced apart so as to fit within a rat trap setting device. Inner channel 602 has inner lateral surfaces 604a-b spaced laterally apart to fit the platform of a mouse trap within. The depth/height of inner channel 602 also matches the height of a corresponding mouse trap platform. A pair of mouse trap guides 624a-b extend inward from a top surface of the main body of adapter 600 across part of inner channel 602. Guides 624a-b serve to secure the mouse trap within channel 602. A beveled front surface 616 of adapter 600 facilitates placing the set mouse trap on a floor. A rear surface 618 of adapter 600 abuts rat trap setting device.

FIGS. 4-B shows an isometric view of a mouse trap 660 disposed within the mouse trap adapter 600 of FIG. 4-A according to some embodiments of the present invention. As illustrated, guides 624a-b are disposed over the platform of mouse trap 660 when mouse trap 660 is slid within channel 602, constraining the vertical motion of mouse trap 660.

FIGS. 4-C shows an isometric view of a mouse trap 660 disposed within the mouse trap adapter 600 of FIG. 4-A, which is in turn secured within a rat trap setting device 10 as shown in FIGS. 1-A-D according to some embodiments of the present invention. Such a mouse trap adapter may be used in conjunction with other rodent trap setting devices, such as the ones shown in FIGS. 2-3, for example. As shown in FIG. 4-C, lateral guides 24a-b enclose and secure mouse trap adapter 600 and its enclosed mouse trap 660 within trap setting device 100 while a user sets mouse trap 660. In particular, safety catch 38 slides over and secures the mouse trap kill bar, and clamping arm 36 presses onto the mouse trap platform, securing within device 10 the assembly formed by mouse trap 660 and adapter 600. After a user has set mouse trap 660, clamping arm 36 and safety catch 38 are released, and the resulting forward motion of the setting device backstop ejects the assembly formed by mouse trap 660 and adapter 600, which may then be placed onto the floor or other desired location. Mouse trap 660 may then be slid out of adapter 600 if adapter 600 is to be reused, or kept within adapter 600, as desired.

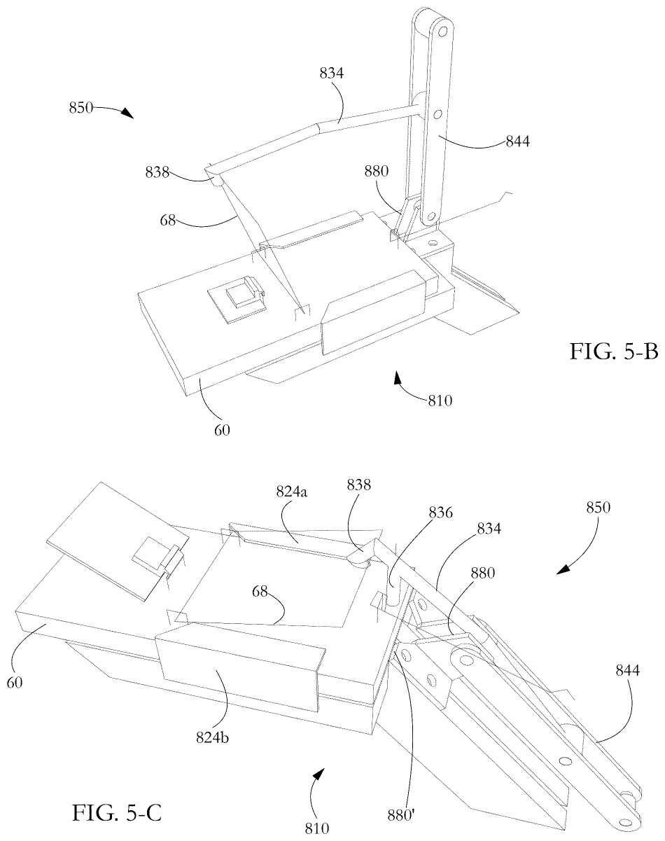

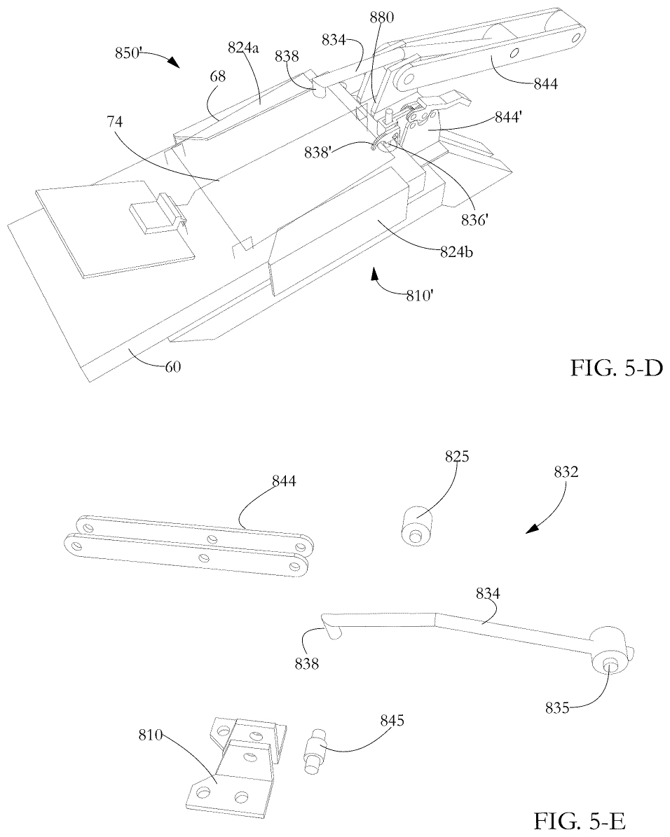

FIG. 5-A shows an isometric view of a rodent trap setting assembly 850 comprising another hand-held rodent trap setting device 810 and rodent trap 60 in an initial configuration, prior to the rodent trap arm being set, according to some embodiments of the present invention. Trap setting device 810 differs from the device 10 shown in FIGS. 1-A-C principally in that device 810 has a kill bar pulling arm and associated linker assembly, which may be implemented as described below using a pull clamp instead of a toggle clamp. Trap setting device 810 includes a base 812 having a planar upper surface 814 configured to support a rodent trap 60. Base 812 has a beveled/angled front/distal surface 816, shaped to facilitate setting down the trap on the floor after arming, as described below. A rear/proximal surface 818 of base 812 faces the arm of an end user holding trap setting device 810 during its operation.

A handle 822 is attached to base 812 along the rear side of base 812, and extends generally downward and outward from base 812. A pair of lateral trap guides 824a-b are situated opposite each other along corresponding lateral sides of base 812.

A pulling arm assembly 832 is attached to base 812 along the rear side of base 812, and extends generally upward from base 812, above upper surface 814. Pulling arm assembly 832 includes a pivotable pulling arm 834 mounted on a horizontal pivot and capable of pivoting in a vertical plane. Pulling arm 834 includes a frontal/distal hook/catch 838, configured to grab and pull the distal, transverse side of kill bar 68 as described below. In some embodiments, hook 838 is placed so that it grabs the transverse side of kill bar 68 slightly off-center (e.g. within one or a few mm of the center, more particularly within less than about half an inch from the center), to provide room at the center for the normal operation/setting of rodent trap 60. Pulling arm assembly 832 further includes a linking arm 844 mounted on base 812 and onto which pulling arm 834 is mounted. A frontal/distal end 840 of linking arm 844 may serve as an actuator, configured to be operated by a user's hand in a generally-longitudinal direction to move pulling arm 834 as illustrated below.

FIG. 5-B shows an isometric view of a rodent trap setting assembly 850 comprising the hand-held rodent trap setting device 810 and rodent trap 60 of FIG. 5-A with kill bar 68 in an intermediate configuration between initial and armed, and FIG. 5-C illustrates assembly 850 with kill bar 68 in an armed/spring-loaded configuration along the proximal end of rodent trap 60, according to some embodiments of the present invention. As shown in FIG. 5-B, an inner surface of hook/catch 838 engages kill bar 68, and pulls kill bar 68 rearward toward an armed position in response to a user pulling linking arm 844 rearward. A linker assembly backstop 880 abuts against the rear of the rodent trap platform, preventing backward motion of rodent trap 60 once rodent trap 60 is aligned so that pulling arm 834 is aligned with kill bar 68. An exemplary resulting armed configuration is shown in FIG. 5-C.

As shown in FIG. 5-C, in an armed configuration, pulling arm 834 holds kill bar 68 back in a tensioned, set configuration. Lateral guides 824a-b hold down the trap platform, exerting a counter-torque that the prevents the upward rotation of the distal end of rodent trap 60 in response to the downward force exerted by pulling arm 834 at the proximal end of rodent trap 60. Rodent trap 60 is thus pressed against the base of setting device 810, preventing the motion/sliding of rodent trap 60 relative to the upper surface of setting device 810. A backstop 880′ prevents the rearward motion of rodent trap 60.

A clamping arm 836 is rigidly coupled to, and preferably integrally formed with, pulling arm 834. Clamping arm 836 extends generally vertically downward when pulling arm 834 is in a generally-horizontal orientation. When pulling arm 834 is in retracted position as illustrated in FIG. 5-C, clamping arm 836 contacts and presses down on the platform of rodent trap 60, securing rodent trap 60 in place against the base of device 810. Clamping arm 836 may include a terminal rubber or polymer tip, as described above.

FIG. 5-D illustrates another rodent trap setting assembly 850′ in an armed configuration, according to some embodiments of the present invention. A rodent trap setting device 810′ includes an additional safety catch 838′, which secures kill bar 68 after hook 838 brings down kill bar 68 into an armed position, and an associated clamping arm 836′ used to clamp down the rodent trap. A toggle clamp assembly 844′ as described above with reference to FIGS. 1-A-D is used to operate clamping arm 836′ and release safety catch 838′ when rodent trap 60 is to be set down.

FIG. 5-E shows an exploded view of various parts of pulling arm assembly 832 according to some embodiments of the present invention. Pulling arm assembly 832 comprises pulling arm 834, linking arm 844, and a mount 810. A number of pins 825, 835, 845, are provided as separate parts (825, 845) or integrated into one of the other parts (835). Each pin engages a matching aperture to creates a pivot joint as illustrated. In particular, linking arm 844 includes matching pairs of proximal, intermediate and distal apertures defined along two parallel plates. The proximal apertures receive pin 845 to pivotably couple to mount 810. The distal apertures receive pin 825 to stabilize linking arm 844, particularly in the presence of force applied by a user's hand to the distal part of linking arm 844. The intermediate aperture receives pin 835, providing a pivotable connection to pulling arm 834 and its associated hook/catch 838.

Connecting the pulling arm at an intermediate location along the lever formed by the linking arm allows reducing the force needed to be applied by a user to generate a given force on the rodent trap kill bar. Since at equilibrium the torque applied by the kill bar to the linking arm at the intermediate location is equal to the torque applied by the user's hand (or driving device such as motor) at the distal end, the ratio of the forces is determined by the ratio of the two lever arm lengths, which yields a lower force (and longer lever arm) at the distal end where the user applies force.

A skilled artisan will be able to ascertain suitable dimensions for the various components described above, for desired applications. As an example, a popular rat trap design has a platform approximately 6 15/16″ long by 3⅜″ wide, and a similar mouse trap design has a platform approximately 3 15/16″ by 1¾″ wide. For such an application, a suitable rat trap setting device base may have slightly larger dimensions, for example approximately 7″ by 3½″. For a ⅝″ rat trap platform thickness, suitable lateral guide dimensions (24a-b in FIG. 1-A) may be 1⅜″ for the vertical sides (26a-b) and ⅜″ for the horizontal covers (30a-b). The thickness and width of handle 22 may be on the order 1″ to 1½″, for example about 1¼″, with gap 22 having a width of about ¼″. The longitudinal distance between the backstop (80) and safety catch (38) and clamping arm (36) is chosen so that when the rodent trap rests against the backstop, the safety catch secures the trap kill bar in an armed position and the clamping arm fits in the space on the trap platform behind the kill bar, as illustrated in FIG. 1-C. The height of the safety catch (38) in a clamped position may be approximately 1″, for example about ⅞″, above the rodent trap platform, which stops the kill bar about ¼″ above the ultimate set position in which the kill bar is secured by the arm bar. An exemplary longitudinal distance between the backstop and center of the arm bar is approximately ¼″. An exemplary longitudinal distance between the backstop and the location where the kill bar is held by the safety catch is about ⅝″.

A skilled artisan will be able to ascertain suitable materials for the various components described above, for desired applications. Since the clamping arm, safety catch, spring and linking mechanisms for clamping the rodent trap and securing the kill bar may be subject to significant and repeated forces, it may be desirable to use relatively strong materials for the components, for example a metal such as steel. A soft and adhesive material such as rubber may be used for the clamping arm tip. Other components, such as the handle, base, lateral guides, and adapter, may be made of softer materials. For example, the lateral guides may be made of wood or aluminum, while the handle, base and adapter may be made of plastics/polymers and/or wood.

Trap-setting devices as described above may be made by first assembling or otherwise manufacturing (e.g. via injection molding or other suitable technique) the device base and handle, and then mounting a clamping arm assembly and/or actuator onto the base. The mounting may be achieved via adhesive and/or one or more fasteners (e.g. screws). The proper alignment of the clamping arm assembly may be tested and/or adjusted prior to finalizing the device, to ensure proper alignment of the clamping arm and safety catch with the rear space on a rodent trap platform and the corresponding kill bar, respectively. In some embodiments, matching depressions and/or raised structures in the base and clamping arm assembly mount may be used to facilitate alignment of the clamping arm in a precisely-defined location along the base. For example, a shallow channel matching the shape of the mount may be defined along the top surface of the base, so that the clamping arm assembly mount fits precisely within the channel. Other examples of depressions and raised structures include longitudinal channels and corresponding rails, and round apertures and corresponding protrusions.

Exemplary rodent trap-setting devices as described above allow end users, particularly users with frail hands and/or poor vision, to conveniently and safely set rodent traps such as rat traps. The user holds a rodent trap gun (trap-setting device) in one hand, and uses his/her other hand to slide the rodent trap onto a base of the rodent trap gun. The hand holding the rodent trap gun is used to engage an actuator to clamp the rodent trap in place, while the other hand pulls the kill bar and secures the kill bar with the safety catch in one user motion. A trigger and/or cock mechanism allows conveniently securing the trap and releasing it when desired, before a user scoops the set trap gently onto a floor or other target surface. The similarity to handgun operation facilitates the convenient and intuitive operation of the devices. One or more adapters as described above allow convenient reuse of the same trap-setting device for different rodent trap sizes, whether different manufacturer designs for the same target rodent (e.g. rat traps made by different manufacturers) or traps designed for different rodents (e.g. rat and mouse traps). The speed, ease of use and safety of the described embodiments also make the trap setting devices useful for pest control professionals, who may set large numbers of traps and/or work in inconvenient locations such as attics.

The pulling arm configurations of FIGS. 5-A-E allows reducing the force applied by a user in order to rotate the kill bar toward its set/armed position, and conveniently combines the structures that set and secure the kill bar, preventing the kill bar from snapping before the trap is ready to be placed. At the same time, the exemplary pulling arm configuration involves a bulkier/longer mechanism than other illustrated embodiments.

A skilled artisan will appreciate that the above exemplary embodiments may be modified in a number of ways. For example, in some embodiments, a separate pull clamp may be used to pull the kill bar in the armed position so that a user does not touch the kill with his/her hands in the process. In some embodiments, the safety catch and clamping arm need not move jointly. For example, a safety catch may be mounted directly on the base, for example on a vertical pivot allowing the safety catch to pivot within a horizontal plane, and may move independently of the clamping arm. Such a safety catch may be particularly useful in conjunction with a pull clamp. A backstop need not be part of the clamping arm assembly as described above, but may be provided separately and made adjustable longitudinally, to accommodate different rodent trap lengths (longitudinal sizes). For example, for a rodent trap having a longer distance between the kill bar (in its armed position) and the rear of the trap platform, the backstop may be adjusted backward to allow the safety catch to align with the kill bar. In some embodiments, various other rotatable joints may be used in lieu of the illustrated pivots, and various other actuator designs may be used to mediate and/or control the application of force by a user's hand or motor.

In some embodiments, the safety catch may be adjustable longitudinally, for example by mounting on a slidable longitudinal arm, in order to adjust the alignment of the safety catch with the kill bar for different trap designs. Such a longitudinal adjustment of the safety catch may allow the use of a fixed backstop. A lateral guide position adjustment mechanism (e.g. channels defined along the base at different locations) may also be provided in order to accommodate different rodent trap widths (transverse sizes). In some embodiments, the handle may be fixedly attached to the base. In some embodiments, the handle may be attached through a horizontal pivot that allows adjusting the handle angle up/down, in a vertical plane. In some embodiments, a trap setting device may be provided with more than one handle, for example one fixed handle and one adjustable handle. The adjustable handle may extend above the base, and may include a pull clamp positioned to grab the kill bar and pull it to the armed position, where the pull clamp is snapped to a locked position in order to secure the kill bar until the trap is set. Such a pull clamp can act as a safety catch, and/or may have a separate safety catch attached to the pull clamp or mounted directly on the base. A clamping arm may be attached as described above, or may mounted on such a pull clamp, for clamping the rodent trap platform to the device base.

While the description above focuses on manually-actuated embodiments, a skilled artisan will appreciate that a motor such as an electromagnetic motor may be used to power the clamping arm and/or associated safety catch. In such an embodiment, the described actuator may include a button or switch rather than a lever. The motor is coupled to the clamping arm and safety catch, and responsive to the actuator. In response to a user's pressing the actuator, the motor drives the motion of the clamping arm and safety catch upward/downward to clamp down and release the rodent trap as described above. The motor may be powered by a battery, to facilitate device portability.

A skilled artisan will further appreciate that features/structures described with reference to certain exemplary embodiments may be used in conjunction with features/structures with reference to other embodiments. For example, a mouse trap adapter and/or safety catch as described with reference in particular embodiments may be used with surrounding structures described with reference to any of the other illustrated embodiments. Accordingly, the scope of the invention should be determined by the following claims and their legal equivalents.

1. A hand-held rodent trap-setting device including:
a base for supporting a platform of a rodent trap;
a handle coupled to the base, for allowing a user to hold the trap-setting device;
a clamping arm coupled to the base and configured to contact a top surface of the rodent trap platform to clamp down the rodent trap platform onto the base; and
an actuator coupled to the base and to the clamping arm, operable by the user, and configured to engage and release the clamping arm onto/from the rodent trap platform.

2. The hand-held rodent trap setting device of claim 1, wherein the rodent trap is a rat trap.

3. The hand-held rodent trap setting device of claim 1, further comprising a safety catch mounted on or along the clamping arm such that the safety catch and clamping arm move jointly in response to the user operating the actuator, the safety catch positioned to catch a kill bar of the rodent trap when the rodent trap is mounted on the base and the kill bar is an armed position, thereby preventing the kill bar from snapping on a user's hand while the user sets the rodent trap.

4. The hand-held rodent trap setting device of claim 3, wherein the safety catch has a convex arcuate upper surface shaped to allow the kill bar to slide downwardly past the upper surface as the kill bar is being armed, and a concave arcuate lower surface shaped to catch the kill bar when the kills bar in the armed position.

5. The hand-held rodent trap setting device of claim 3, wherein the safety catch is mounted on a horizontal pivot, and is configured to pivot along a vertical plane between an arming position allowing the kill bar to slide downward past the safety catch, and a catching position preventing the kill bar from snapping upward when armed.

6. The hand-held rodent trap setting device of claim 3, wherein the clamping arm and safety catch are positioned off-center relative to a central longitudinal axis of the base, to facilitate securing the kill bar using an arm bar of the rodent trap while the safety catch engages the kill bar.

7. The hand-held rodent trap setting device of claim 1, wherein the actuator extends generally rearwardly from the base, and is operable by a user's thumb.

8. The hand-held rodent trap setting device of claim 1, wherein the actuator extends generally downward through an aperture defined through the base, and is operable by a user's fingers.

9. The hand-held rodent trap setting device of claim 1, wherein the actuator comprises a cocking member extending generally rearwardly from the base and operable by a user's thumb, and a trigger component extending generally downward through an aperture defined through the base and operable by a user's fingers.

10. The hand-held rodent trap setting device of claim 1, further comprising a backstop coupled to the actuator and configured to backstop a rearward motion of the rodent trap platform relative to the base when the clamping arm clamps down the rodent trap platform onto the base, and to push forward the rodent trap platform relative to the base when the clamping arm is released via the actuator.

11. The hand-held rodent trap setting device of claim 1, wherein the base has a beveled front surface angled to facilitate placing the rodent trap onto a flat surface and sliding the base from under the rodent trap.

12. The hand-held rodent trap setting device of claim 1, further comprising a pair of lateral guides coupled to the base and positioned to guide the rodent trap platform in a space defined between the guides and the base.

13. The hand-held rodent trap setting device of claim 1, further comprising an adapter mounted on the base, the adapter comprising a longitudinal channel sized to accommodate the rodent trap.

14. The hand-held rodent trap setting device of claim 1, wherein the clamping arm comprises a vertical member terminating in a rubber tip configured to contact and press down a rear part of the platform of the rodent trap.

15. The hand-held rodent trap setting device of claim 1, further comprising a pulling arm configured to catch a transverse side of a rodent trap kill bar, and to pull the kill bar to an armed position.

16. A method of setting a rodent trap, comprising:
holding a handle of a hand-held rodent trap-setting device in a first hand, the handle being coupled to a base of the trap-setting device;
mounting a rodent trap onto the base;
engaging an actuator coupled to the base and to a clamping arm of the trap-setting device to clamp down the rodent trap onto the base using the clamping arm, the clamping arm contacting a top surface of a platform of the rodent trap; and
setting the rodent trap while clamped down onto the base.

17. The method of claim 16, wherein the rodent trap is a rat trap.

18. The method of claim 16, wherein the trap-setting device comprises a safety catch mounted on or along the clamping arm such that the safety catch and clamping arm move jointly in response to the user operating the actuator, the safety catch positioned to catch a kill bar of the rodent trap when the rodent trap is mounted on the base and the kill bar is an armed position, thereby preventing the kill bar from snapping on a user's hand while the user sets the rodent trap.

19. The method of claim 18, wherein the safety catch has a convex arcuate upper surface shaped to allow the kill bar to slide downwardly past the upper surface as the kill bar is being armed, and a concave arcuate lower surface shaped to catch the kill bar when the kills bar in the armed position.

20. The method of claim 18, wherein the safety catch is mounted on a horizontal pivot, and is configured to pivot along a vertical plane between an arming position allowing the kill bar to slide downward past the safety catch, and a catching position preventing the kill bar from snapping upward when armed.

21. The method of claim 18, wherein the clamping arm and safety catch are positioned off-center relative to a central longitudinal axis of the base, to facilitate securing the kill bar using an arm bar of the rodent trap while the safety catch engages the kill bar.

22. The method of claim 16, wherein the actuator extends generally rearwardly from the base, and is operable by a user's thumb.

23. The method of claim 16, wherein the actuator extends generally downward through an aperture defined through the base, and is operable by a user's fingers.

24. The method of claim 16, wherein the actuator comprises a cocking member extending generally rearwardly from the base and operable by a user's thumb, and a trigger component extending generally downward through an aperture defined through the base and operable by a user's fingers.

25. The method of claim 16, further comprising employing a backstop coupled to the actuator to backstop a rearward motion of the rodent trap platform relative to the base when the clamping arm clamps down the rodent trap platform onto the base, and to push forward the rodent trap platform relative to the base when the clamping arm is released via the actuator.

26. The method of claim 16, wherein the base has a beveled front surface angled to facilitate placing the rodent trap onto a flat surface and sliding the base from under the rodent trap.

27. The method of claim 16, further comprising employing a pair of lateral guides coupled to the base to guide the rodent trap platform in a space defined between the guides and the base.

28. The method of claim 16, wherein mounting the rodent trap onto the base comprises accommodating the rodent trap into a longitudinal channel of an adapter, and mounting the adapter onto the base.

29. The method of claim 16, wherein the clamping arm comprises a vertical member terminating in a rubber tip configured to contact and press down a rear part of the platform of the rodent trap.

30. The method of claim 16, further comprising employing a pulling arm to catch a transverse side of a rodent trap kill bar, and to pull the kill bar to an armed position.

31. The hand-held rodent trap setting device of claim 1, wherein the handle extends generally below the base.

32. The method of claim 16, wherein the handle extends generally below the base.
